(19) United States
(12) Patent Application Publication
(10) Pub. No.: US 2007/0174271 A1
(43) Pub. Date: Jul. 26, 2007

(54) Database system with second preprocessor and method for accessing a database

(76) Inventors: Ulf Mattsson, Cos Cob, CT (US); Yigal Rozenberg, Rehovot (IL)

Correspondence Address: EDWARDS ANGELL PALMER & DODGE LLP, P.O. BOX 55874, BOSTON, MA, 02205, US

(21) Appl. No.: 11/357,926

(22) Filed: Feb. 17, 2006

Related U.S. Application Data
(60) Provisional application No. 60/654,367, filed on Feb. 18, 2005.
(60) Provisional application No. 60/654,129, filed on Feb. 18, 2005.

(51) Int. Cl. G06F 17/30

(52) U.S. Cl. 707/5

(57) ABSTRACT

A database system includes a database, a first preprocessor in communication with the database for receiving queries from a client application, a second preprocessor, for executing cryptographic operations on data, and a dispatcher, arranged to divide a query into at least a first and a second sub-query, and to dispatch the first sub-query to the first pre-processor and the second sub-query to the second preprocessor. In some implementations, the second preprocessor is adapted to encrypt data to be inserted into the database and to insert the encrypted data into the database, and to request encrypted data from the database and to decrypt the encrypted data.

### RELATED APPLICATION

This application claims priority from co-pending provisional U.S. application Ser. No. 60/654,367, filed Feb. 18, 2005, and provisional U.S. application Ser. No. 60/654,129, also filed Feb. 18, 2005.

### TECHNICAL FIELD

The present description relates to database systems, and in particular, to database management systems having encrypted data.

### BACKGROUND

When using encryption in a database environment, the actual cryptographic operations can be accomplished by a DBMS (database management system) on the database side or by an application. When the DBMS encrypts data, many applications are unaffected by the encryption. Thus DBMS-based encryption can be implemented without making major changes in legacy applications. However, this also means that unless additional measures are taken, any data that enters or leaves the database will be decrypted, and will therefore be transported as clear text.

A further vulnerability of DBMS-based encryption is that the encryption key used to encrypt data is often stored in a database table inside the database, protected by native DBMS access controls. Frequently, the users who have access rights to the encrypted data also have access rights to the encryption key. This can create a security vulnerability because the encrypted text is not separated from the key used to decrypt it.

Another drawback of DBMS encryption is that a limited number of servers bears the processing load on behalf of a potentially unlimited number of applications. Because encryption and decryption are performed within the database, the DBMS is asked to perform additional processing, not only when the data is stored, but each time it is accessed.

Moving the encryption to the applications that generate the data improves security. However, this may require source code level changes to the applications to enable them to handle the cryptographic operations. In addition, having applications carry out encryption may also prevent data sharing between applications. Critical data may no longer be shared between different applications, even if the applications are re-written. Thus, moving encryption to the application may be unsuitable for large scale implementation, and may create more communication overhead, and more server administration.

### SUMMARY

In general, in some aspects, a database system includes a database, a first preprocessor in communication with the database for receiving queries from a client application, a second preprocessor, for executing cryptographic operations on data, and a dispatcher, arranged to divide a query into at least a first and a second sub-query, and to dispatch the first sub-query to the first pre-processor and the second sub-query to the second preprocessor.

In some implementations, the system includes one or more of the following features. The second preprocessor is adapted to encrypt data to be inserted into the database and to insert the encrypted data into the database. The second preprocessor is adapted to request encrypted data from the database and to decrypt the encrypted data. The second preprocessor is arranged to intercept a query from the application, to parse the query, and to forward the parsed query to the dispatcher. The second preprocessor is configured to parse a query belonging to a predefined subset of possible queries. The second query processor is configured to amend the query to request encrypted information from the database, and to forward the amended query to the database. Parsing a query includes recognizing a subset of the Standard Query Language (SQL). The second preprocessor is further configured to amend a table name of a recognized SQL query. The first preprocessor and the second preprocessor are both implemented on the same server. The second preprocessor is implemented in an intermediate server, arranged between the application and the database management system. The intermediate server is a proxy server.

In general, in some aspects, a database system for accessing a database includes a first query processor for relaying queries from a client application to the database and a second query processor, provided between the client application and the first query processor. The second query processor is configured to receive a database query from a client application, determine that the database query is a request to retrieve encrypted data from the database, and on the basis of the determination, retrieve the encrypted data from the database, decrypt the encrypted data, and return the decrypted data to the client application.

In general, in some aspects, a database system receives a database query from an application, determines that the database query is a request to insert encrypted data into the database, encrypts the data, and inserts the data into the database.

Some implementations include one or more of the following features. The database system recognizes a database query as belonging to a predefined subset of database queries, and, for such a recognized query, determines if the query is intended to request encrypted data from the database. The database system amends the query to request encrypted information from the database and forwards the amended query to the database. The subset is a subset of the Standard Query Language (SQL). The database system amends a table name of a recognized SQL query.

In general, in some aspects, a database system includes a database having a first portion encrypted at a first encryption level and a second portion encrypted at a second encryption level that differs from the first encryption level; a first preprocessor configured to receive a database query from a client application, the database query requesting interaction with first data from the first portion and requesting interaction with second data from the second portion; a second preprocessor in data communication with the first preprocessor, the second preprocessor configured to executed a cryptographic operation on data; and a dispatcher in data communication with the first preprocessor, the dispatcher being configured to separate a database query into a first sub-query that requests interaction with the first data, and a second sub-query that requests interaction with the second data, to dispatch the first sub-query to the first preprocessor, and to dispatch the second sub-query to the second preprocessor.

Other general aspects include other combinations of the aspects and features described above and other aspects and features expressed as methods, apparatus, systems, program products, and in other ways.

Advantages and features will become apparent from the following description and claims.

### DESCRIPTION OF DRAWINGS

FIG. 1 is a schematic block diagram of a database system including a preprocessor.

FIG. 2 is a flowchart of a method suitable for implementation by in the system in FIG. 1.

Like reference symbols in the various drawings indicate like elements.

### DETAILED DESCRIPTION

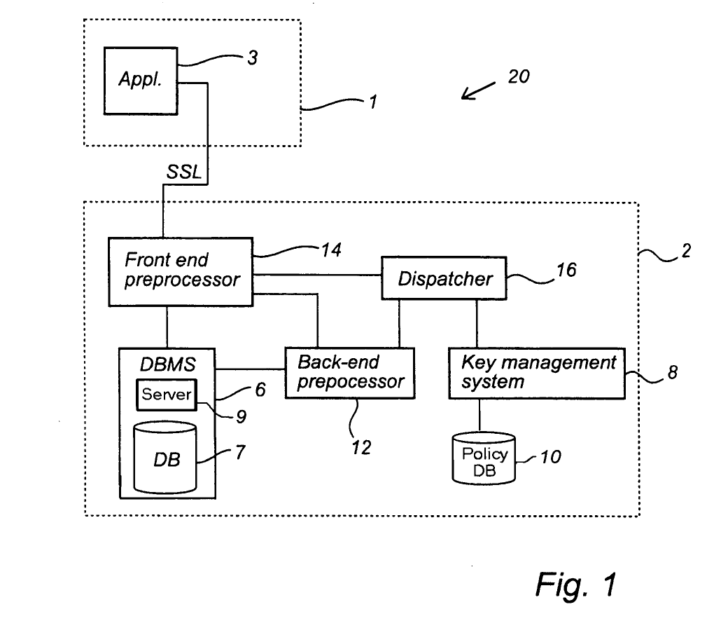

FIG. 1 shows a database system 20 having a client 1 and a server platform 2, respectively. The client 1 comprises a client application 3, while the server platform 2 comprises a database management system (DBMS) 6 including a database server module 9 (e.g., a Secure.data(tm) from Protegrity Inc.), and a database 7.

The server platform 2 also includes a key management system 8. A suitable key management system 8 includes a security system (SS) (e.g., Secure.server(tm) from Protegrity Inc.), a security administration system (SAS) (e.g., Secure.Manager(tm) from Protegrity Inc.) and a data security extension (DSE), (e.g., Secure.data(tm) from Protegrity Inc.). The SAS is used by the administrator to manage a policy database 10, which is accessible through the key management system 8 to determine what actions (e.g. reads or writes to specific tables of the database 7) an individual user of client application 3 is permitted to carry out.

The database system further comprises a back-end preprocessor 12, adapted to receive queries from the application 3. A front-end preprocessor 14 is in communication with the DBMS 6, and arranged to access information in the database 7. If the database 7 is encrypted, the back-end preprocessor 12 is arranged to handle cryptographic operations.

As noted above, between the application 3 and the DBMS 6 is a front-end preprocessor 14 arranged to intercept any query sent from the application 3 to the back-end preprocessor 12. Preferably, the front-end preprocessor 14 is arranged to recognize a subset of the query language used, e.g. SQL. This recognized subset can include simple queries like: “select age from person” and “insert into person values ( ‘John’, ‘smith’, 34).” The front-end preprocessor 14 is further be arranged to handle cryptographic operations, thus providing an alternative way to enable encryption of the database information.

Connected to both preprocessors 12, 14 and to the key management system 8 is a dispatcher 16 arranged to receive any query intercepted by the front-end preprocessor 14 and to select, based on information in the policy database 10, which preprocessor to use to handle communication with the database 7. In making this selection, the dispatcher also determines which preprocessor will handle cryptographic operations.

The front-end preprocessor 14 can be implemented as a separate process, or can be implemented as an intermediate server, between the client 1 and the server platform 2, e.g., as a proxy server. The components of the server platform 2 may be integrated into one hardware unit, or distributed among several hardware units.

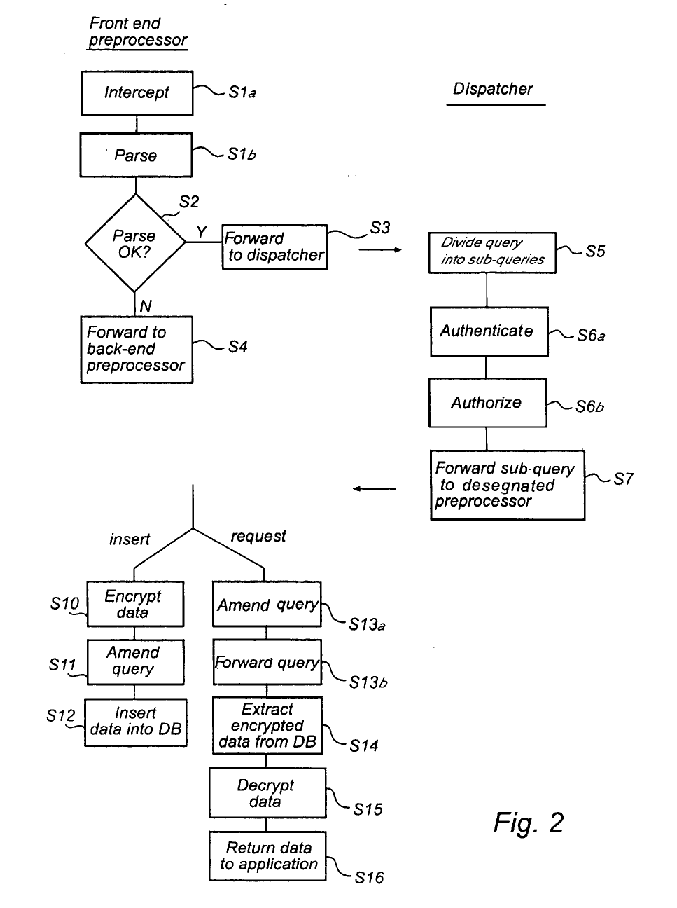

Referring now to FIG. 2, the front-end preprocessor 14 intercepts a query (step S1a) sent to the database 7 from the client application 3, and attempts to parse this query (step S1b). If parsing is successful (step S2), the query is forwarded to the dispatcher 16 (step S3). In the illustrated example, with only two preprocessors 12, 14, unrecognized queries are forwarded to the back-end preprocessor 12 (step S4) to be handled in the normal way. In a general case, with a plurality of preprocessors, the dispatcher 16 decides where to send an unrecognized query.

Upon receiving the query, the dispatcher 16. divides the query into sub-queries that relate to different portions of the database (step S5). These portions can include selected rows, selected columns, or combinations thereof. These different portions of the database 7 typically have different levels of security and/or encryption.

The dispatcher 16 then authenticates and authorizes the client application 3 (steps S6a and S6b), typically by accessing the key management system 8. After authentication and authorization, the dispatcher 16 forwards (step S7) each sub-query to whichever preprocessor 12, 14 is designated by the key management system 8 to handle encryption of the particular portion of the database 7 associated with that sub-query.

Sub-queries that are sent to the back-end preprocessor 12 are handled with any encryption that is implemented in the DMBS 6. However, sub-queries that are sent to the front-end preprocessor 14 are handled with additional encryption, thus enabling different types of encryption for different portions of the database 7.

In case of an insert operation, the front-end preprocessor 14 encrypts the data in the query (step S10), amends the query (step S11) to replace the data with the encrypted data, and then forwards the query to the DMBS 6 for insertion into the database 7, (step S12).

In case of a request operation, the front-end preprocessor 14 amends the query (step S13a), and forwards the amended query to the DMBS 6 (step S13b). The requested information is extracted from the database 7 (step S14) and decrypted (step S14). The decrypted result is then returned to the client application 3 (step S15).

As an example, if the query “select age from person” is recognized and determined by the dispatcher 16 to involve an encrypted table, the query can be amended to “select age from person—enc,” to indicate that data is to be selected from an encrypted portion of the database. When the encrypted data is received from the database 7, the front-end preprocessor 14 decrypts the data before sending it to the client application 3.

In the same way, “insert into person ‘john’, ‘smith’, 34” can be amended to “insert into person_enc ‘john’, ‘smith’, 34” to indicate that the data is to be inserted into an encrypted portion of the database. At the same time, the front-end preprocessor 14 encrypts the data fields in the query, so that the forwarded query will look like “insert into person_enc xxxxx xxxxx xx”. This query ensures that encrypted data is inserted into the database, without requiring any encryption by the DBMS 6.

As is clear from the above, the front-end preprocessor 14 handles cryptographic activity relating to selected portions of the database. Therefore, it should be noted that in a case in which the database is not itself adapted to handle encryption, the server platform 2 can on its own create an encrypted interface to the database 7, allowing for cryptography of selected portions of the database. The particular portions of the database to be encrypted are governed by the policy database 10.

In some embodiments, the front-end preprocessor 14 is an add-on to an existing database system. The front-end preprocessor 14 need not be configured to handle SQL syntax errors, as any unrecognized queries (including incorrect queries) are simply forwarded to the DBMS 6 (step S4 in FIG. 3).

However, in other embodiments, the front-end preprocessor 14 is configured to interpret the entire SQL language. This allows the front-end preprocessor 14 to select tables in the policy database 10 and to determine what tables are subject to cryptographic operations.

The front-end preprocessor 14 can support secure socket layer (SSL) with strong authentication to enable an SSL channel between client and server. The certificate used for authentication can be matched to the database the client application 3 accessed, to provide strong authentication. In the case where the front-end preprocessor 14 is integrated into the DBMS 6, the DBMS 6 will thus have full control of the authentication process. However, it is also possible to implement the DBMS 6 and the preprocessor 14 separately, for example, by implementing the preprocessor 14 as an intermediate server.

It is clear that many modifications of the above described examples will be possible for the skilled person without departing from the spirit and scope of the invention. Such modifications could relate to, for example, the details of the DBMS 6 and its components, or the details of the client-server interface. For example, the front-end preprocessor 14 can be implemented physically separate from the database server platform 2, in a different unit. Accordingly, other embodiments are within the scope of the following claims.

What is claimed is:

1. A database system comprising:
a computer readable medium having encoded thereon information representative of a database,
a first preprocessor in communication with the database for receiving queries from a client application,
a second preprocessor, for executing cryptographic operations on data, and
a dispatcher, arranged to divide a query into at least a first and a second sub-query, and to dispatch the first sub-query to the first pre-processor and the second sub-query to the second preprocessor.

2. The system in claim 1, wherein said second preprocessor is adapted to encrypt data to be inserted into the database and to insert said encrypted data into the database.

3. The system in claim 1, wherein said second preprocessor is adapted to request encrypted data from the database and to decrypt said encrypted data.

4. The system in claim 1, wherein said second preprocessor is arranged to intercept a query from said application, to parse said query, and to forward said parsed query to the dispatcher.

5. A system according to claim 4, wherein the second preprocessor is configured to parse a query belonging to a predefined subset of possible queries.

6. A system according to claim 5, wherein the second query processor is configured to amend the query to request encrypted information from the database, and to forward said amended query to the database.

7. A system according to claim 5, wherein parsing a query comprises recognizing a subset of the Standard Query Language (SQL).

8. A system according to claim 7, wherein the second preprocessor is further configured to amend a table name of a recognized SQL query.

9. The system in claim 1, wherein said first preprocessor and said second preprocessor are both implemented on the same server.

10. The system in claim 1, wherein said second preprocessor is implemented in an intermediate server, arranged between the application and the database management system.

11. The system in claim 10, wherein said intermediate server is a proxy server.

12. A database system for accessing a database, said system comprising
a first query processor for relaying queries from a client application to the database, and
a second query processor, provided between the client application and the first query processor, said second query processor being configured to:
receive a database query from a client application,
determine that said database query is a request to retrieve encrypted data from the database, and
on the basis of the determination, retrieve said encrypted data from the database, decrypt said encrypted data, and return said decrypted data to the client application.

13. A method for accessing information in a database, said method comprising:
receiving a database query from an application,
determining that said database query is a request to insert encrypted data into the database,
encrypting said data, and
inserting said data into the database.

14. The method of claim 13, further comprising:
recognizing a database query as belonging to a predefined subset of database queries, and,
for such a recognized query, determining if said query is intended to request encrypted data from the database.

15. The method of claim 14, further comprising amending the query to request encrypted information from the database, and forwarding the amended query to the database.

16. The method of claim 14, wherein the subset is a subset of the Standard Query Language (SQL).

17. The method of claim 14, further comprising amending a table name of a recognized SQL query.

18. A method of accessing a database comprising:
receiving a database query from a client application,
in response to the query, executing cryptographic operations on data,
dividing the query into at least a first and a second sub-query, and
dispatching the first sub-query to a first pre-processor and the second sub-query to a second preprocessor.

19. A computer readable medium having encoded thereon instructions to cause a data processing system to:
upon receiving a query from a client application,
execute cryptographic operations on data,
divide the query into at least a first and a second sub-query, and
dispatch the first sub-query to a first pre-processor and the second sub-query to a second preprocessor.

20. A system comprising:
a computer-readable medium having encoded thereon information representative of a database, the database having
a first portion encrypted at a first encryption level and
a second portion encrypted at a second encryption level that differs from the first encryption level;
a first preprocessor configured to receive a database query from a client application, the database query
requesting interaction with first data from the first portion and
requesting interaction with second data from the second portion;
a second preprocessor in data communication with the first preprocessor, the second preprocessor configured to executed a cryptographic operation on data; and
a dispatcher in data communication with the first preprocessor, the dispatcher being configured
to separate a database query into
a first sub-query that requests interaction with the first data, and
a second sub-query that requests interaction with the second data,
to dispatch the first sub-query to the first preprocessor, and
to dispatch the second sub-query to the second preprocessor.

21. An article of manufacture having encoded thereon instructions for causing a data processing system to carry out the method of claim 13.
